(19) United States
(12) Patent Application Publication
(10) Pub. No.: US 2011/0049229 A1
(43) Pub. Date: Mar. 3, 2011

(54) Carton with Dispensing and Reinforcing Features

(76) Inventors: Garry Gillespie, Loretto, TN (US); Paul King, Loretto, TN (US); William A. Hollman, Ethridge, TN (US)

(21) Appl. No.: 12/875,499

(22) Filed: Sep. 3, 2010

Related U.S. Application Data
(60) Provisional application No. 61/275,878, filed on Sep. 3, 2009.

(51) Int. Cl. B65D 43/14; B31B 1/26

(52) U.S. Cl. 229/123.2; 493/162

(57) ABSTRACT

A combination blank formed from a first blank attached to a second blank is described. The first blank includes panels defined between first and second transverse fold lines that are spaced a first distance apart. The first blank includes a dispensing flap pattern, to which adhesive is not applied. The second blank includes panels each having a width less than the first distance. The combination blank includes corresponding panels from the first blank and the second blank. The first blank can include a tear strip adjacent the dispensing flap pattern, with the tear strip generally not receiving adhesive. Optionally, the first blank can include a sift pocket formation, to which generally adhesive is not applied. The tear string can be positioned between the sift pocket formation and the dispensing flap pattern.

### CROSS-REFERENCE TO RELATED APPLICATION

This application claims the benefit of U.S. Provisional Application No. 61/275,878, which was filed on Sep. 3, 2009.

### INCORPORATION BY REFERENCE

U.S. Provisional Application No. 61/275,878, which was filed on Sep. 3, 2009, is hereby incorporated by reference for all purposes as if presented herein in its entirety.

### BACKGROUND OF THE DISCLOSURE

Cartons are useful for holding and transporting articles. In order to facilitate dispensing of articles from a carton, it is beneficial to form a dispenser with a portion of the carton.

### SUMMARY

In a first aspect, the present invention includes a combination blank that includes a first blank attached to a second blank by an adhesive. The first blank includes at least a first panel connected to a second panel along a first fold line. The second panel is connected to a third panel along a second fold line. The third panel is connected to a fourth panel along a third fold line. The fourth panel is connected to a fifth panel along a fourth fold line. The first blank includes first end flaps disposed along a first transverse fold line and second end flaps disposed along a second transverse fold line. The first transverse fold line and the second transverse fold line are transverse to the first fold line, the second fold line, the third fold line, and the fourth fold line. The first transverse fold line is spaced a first distance from the second transverse fold line. The first blank includes a dispensing flap pattern. The second blank includes a first panel, a second panel, a third panel, a fourth panel, and a fifth panel, with each of the first panel, the second panel, the third panel, the fourth panel, and the fifth panel having a width less than the first distance.

The combination blank includes a first combination panel that includes the first panel of the first blank and the first panel of the second blank; a second combination panel that includes the second panel of the first blank and the second panel of the second blank; a third combination panel that includes the third panel of the first blank and the third panel of the second blank; a fourth combination panel that includes the fourth panel of the first blank and the fourth panel of the second blank; and a fifth combination panel that includes the fifth panel of the first blank and the fifth panel of the second blank. An adhesive is applied to either the first blank or the second blank to attach the first blank to the second blank to form the combination blank. However, the adhesive generally is not applied to the dispensing flap pattern. Further, the first blank can include a tear strip, and the tear strip can be adjacent the dispensing flap pattern. Generally, the adhesive also is not applied to the tear strip. Further still, the dispensing flap pattern can be defined at least partially by at least one tear line, and the at least one tear line can include a tear line pattern. In another embodiment, the first blank can include a sift pocket formation. Generally, the adhesive is not applied to the sift pocket formation. Further, the first blank can include a tear string, and the tear string can be positioned between the sift pocket formation and the dispensing flap pattern.

In a second aspect, the present invention provides a carton formed from a combination blank. The combination blank includes a first blank attached to a second blank by an adhesive. The first blank generally includes a first panel connected to a second panel along a first fold line. The second panel is connected to a third panel along a second fold line. The third panel is connected to a fourth panel along a third fold line. The fourth panel is connected to a fifth panel along a fourth fold line. The first blank includes first end flaps disposed along a first transverse fold line and second end flaps disposed along a second transverse fold line. The first transverse fold line and the second transverse fold line are transverse to the first fold line, the second fold line, the third fold line, and the fourth fold line. The first transverse fold line is spaced a first distance from the second transverse fold line. The first blank includes a dispensing flap pattern. The second blank includes a first panel, a second panel, a third panel, a fourth panel, and a fifth panel. The first panel, the second panel, the third panel, the fourth panel, and the fifth panel of the second blank each have a width less than the first distance. An adhesive is applied to either the first blank or the second blank. The adhesive generally is not applied to the dispensing flap pattern.

The combination blank has a first combination panel that includes the first panel of the first blank and the first panel of the second blank; a second combination panel that includes the second panel of the first blank and the second panel of the second blank; a third combination panel that includes the third panel of the first blank and the third panel of the second blank; a fourth combination panel that includes the fourth panel of the first blank and the fourth panel of the second blank; and a fifth combination panel that includes the fifth panel of the first blank and the fifth panel of the second blank. The carton includes a first side formed from the first combination panel and the fifth combination panel. The first combination panel and the fifth combination panel are attached together. The carton further includes a second side formed from the second combination panel, a third side formed from the third combination panel, a fourth side formed from the fourth combination panel, a first end formed from the first end flaps, and a second end formed from the second end flaps. Further, the first blank can include a tear strip, and the tear strip can be adjacent the dispensing flap pattern. Generally, the adhesive is not applied to the tear strip. Further still, the dispensing flap pattern can be defined at least partially by at least one tear line, and the at least one tear line can include a tear line pattern. In another embodiment, the first blank can include a sift pocket formation. Generally, the adhesive is not applied to the sift pocket formation. Further, the first blank can include a tear string, and the tear string can be positioned between the sift pocket formation and the dispensing flap pattern.

In a third aspect, the present invention includes a method of forming a carton from a combination blank. The method includes: providing a first blank having at least a first panel connected to a second panel along a first fold line, the second panel is connected to a third panel along a second fold line, the third panel is connected to a fourth panel along a third fold line, and the fourth panel is connected to a fifth panel along a fourth fold line. The first blank includes first end flaps disposed along a first transverse fold line and second end flaps disposed along a second transverse fold line. The first transverse fold line and the second transverse fold line are transverse to the first fold line, the second fold line, the third fold line, and the fourth fold line. The first transverse fold line is spaced a first distance from the second transverse fold line. The first blank includes a dispensing flap pattern.

The method further includes: providing a second blank that includes a first panel, a second panel, a third panel, a fourth panel, and a fifth panel. The first panel, the second panel, the third panel, the fourth panel, and the fifth panel of the second blank each have a width less than the first distance. The method also generally includes: applying an adhesive to either the first blank or the second blank, and forming the combination blank by attaching the first blank to the second blank along the adhesive. The combination blank can include a first combination panel that includes the first panel of the first blank and the first panel of the second blank; a second combination panel that includes the second panel of the first blank and the second panel of the second blank; a third combination panel that includes the third panel of the first blank and the third panel of the second blank; a fourth combination panel that includes the fourth panel of the first blank and the fourth panel of the second blank; and a fifth combination panel that includes the fifth panel of the first blank and the fifth panel of the second blank. The adhesive generally is not applied to the dispensing flap pattern in the combination blank.

Further, the first blank can include a tear strip, and the tear strip can be adjacent the dispensing flap pattern. Generally, the adhesive is not applied to the tear strip. Further still, the dispensing flap pattern can be defined at least partially by at least one tear line, and the at least one tear line can include a tear line pattern. In another embodiment, the first blank can include a sift pocket formation. Generally, the adhesive is not applied to the sift pocket formation. Further, the first blank can include a tear string, and the tear string can be positioned between the sift pocket formation and the dispensing flap pattern.

In a fourth aspect, a reinforced carton as described herein can be formed by a method such as the following: (1) forwarding a web of paperboard that receives a tear string applied thereto, the tear string being adhered to the web by an adhesive on an interior surface of the web, (2) applying and adhering a reinforcing ribbon over the tear string to the interior surface of the web (the adhesive being applied to either the web or the reinforcing ribbon, and the adhesive not being applied to certain areas of the web or reinforcing ribbon such as a section above the tear string to the periphery of the ribbon), (3) cutting a blank from the web, (4) diagonally cutting from the exterior side of the web or blank approximately through the areas not receiving adhesive, with the cuts extending through the blank and through the tear string but not through the reinforcing ribbon, and (5) forming a carton from the blank. Alternatively, steps (3) and (4) can be performed simultaneously. Alternatively still, in lieu of forwarding a paperboard web, a blank can be pre-cut from the web prior to application of the ribbon. In a further alternative, the tear string can be applied to the blank after the blank has been cut from the web. In yet a further alternative, the web with tear string applied can be cut to form a blank prior to the application of the reinforcing ribbon. In still another alternative, the diagonal cuts can be replaced with any other angle or design of such cuts, such as perpendicular to the tear string, as long as the cuts extend through the blank and the tear string. In any of the descriptions or alternatives detailed above, it should be understood that although only one ribbon is discussed, more than one reinforcing ribbon further can be included along the web, blank, sleeve, or carton.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an interior side of a first blank with one embodiment of a glue pattern indicated thereon.

FIG. 2 is a view the first blank of FIG. 1 with a second blank applied over the glue pattern.

FIG. 3 is a perspective view of a carton formed from the blank of FIGS. 1 and 2 with the lid open.

FIG. 4 is a view of an alternate embodiment of a carton blank with an alternate glue pattern and with a sift pocket formation.

Corresponding parts are designated by corresponding reference numbers throughout the drawings.

### DETAILED DESCRIPTION

The present disclosure generally relates to cartons that contain articles such as containers, bottles, cans, detergent, foodstuffs, etc. Cartons according to the present disclosure can accommodate articles of any shape. For the purpose of illustration and not for the purpose of limiting the scope of the disclosure, the following detailed description describes cartons that can enclose food stuffs, detergents, or other household products or the like. In this specification, the terms “lower,” “bottom,” “upper,” and “top” indicate orientations determined in relation to fully erected and upright cartons.

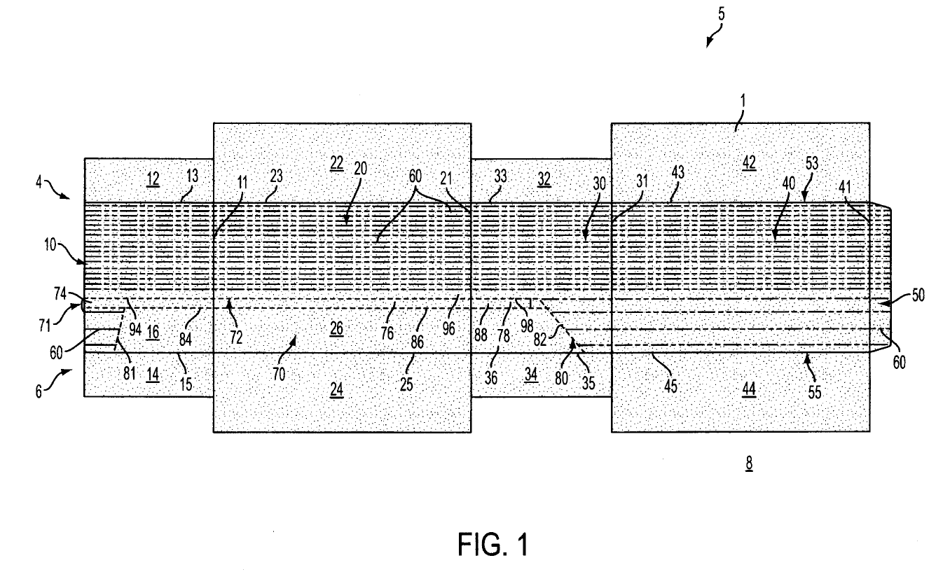

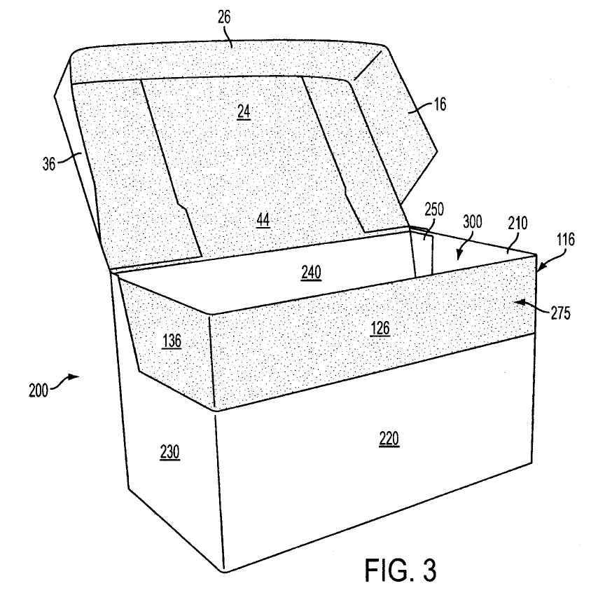

Referring now in more detail to the drawings, FIG. 1 is a view of an interior side of a carton blank 5 with a glue pattern 60 applied thereto. FIG. 1 shows an inside facing surface 1 of carton blank 5 from which a carton 200 (FIG. 3) can be erected. The blank 5 includes a first panel 10 connected to a second panel 20 along a fold line 11. Second panel 20 is connected along a fold line 21 to a third panel 30. Third panel 30 is connected along a fold line 31 to a fourth panel 40. Fourth panel 40 is connected along a fold line 41 to an adhesive flap or panel 50. Along a first end 4 of blank 5, end flap 12 is connected to panel 10 along fold line 13. End flap 14 is connected along a fold line 15 at a second end 6 of panel 10. End flap 22 is connected along a fold line 23 to the first end 4 of panel 20. End flap 24 is connected along a fold line 25 at the second end 6 of panel 20. End flap 32 is connected along a fold line 33 to the first end 4 of panel 30. End flap 34 is connected along a fold line 35 to the second end 6 of panel 30. End flap 42 is connected along a fold line 43 to the first end 4 of panel 40. End flap 44 is connected along a fold line 45 to the second end 6 of panel 40.

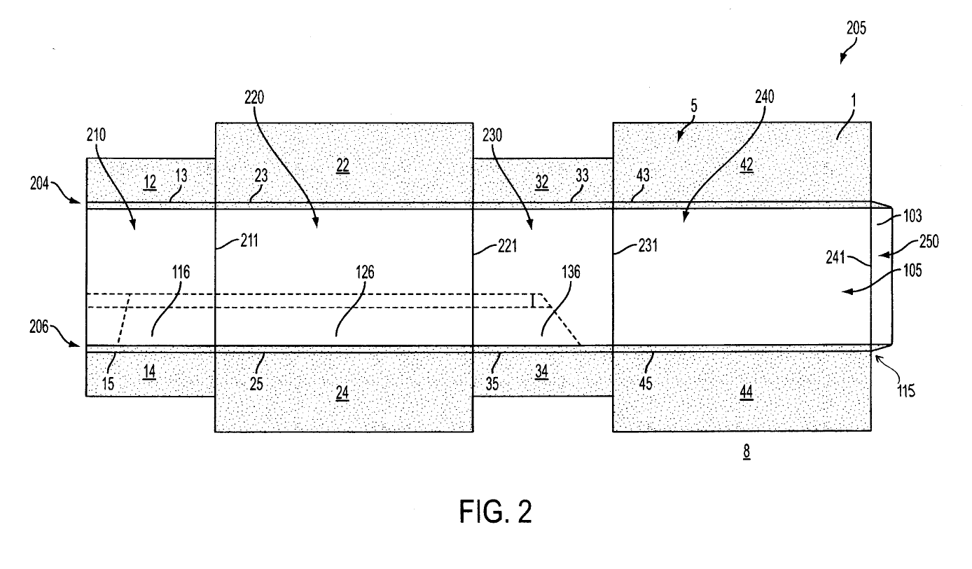

Fold lines 13, 15, 23, 25, 33, 35, 43, 45 are generally transverse to fold lines 11, 21, 31, 41. One or more of fold lines 13, 23, 33, 43 could be replaced by a single fold line, such as indicated at 53, and one or more fold lines 15, 25, 35, 45 could be replaced by a single fold line, such as indicated at 55. End flaps 12, 14, 22, 24, 32, 34, 42, 44 generally extend in a direction away from respective fold lines 13, 15, 23, 25, 33, 35, 43, 45 toward periphery 8 of the blank 5. In lieu of “panels,” the surfaces of carton 200 formed from the blank 5 can be referred throughout the several views to as “sides.” An adhesive or glue is shown applied to blank 5 in a pattern 60. The pattern 60 extends across portions of panels 10, 20, 30, 40, and adhesive flap 50. While the type, size, orientation, continuousness, and placement of glue pattern 60 can vary depending on the size, orientation, and type of blank the pattern 60 is applied to, generally, glue pattern 60 will be applied to blank 5, or to second blank 105 (FIG. 2) to allow registration or alignment of blank 105 (FIG. 2) with blank 5.

The blank 5 generally includes a dispensing feature 70, shown in FIG. 1 as defined by a pattern of tear lines that extend into and/or through portions of at least panels 10, 20, and 30. The dispensing feature 70 includes at least two portions, with a first portion defining a tear tape, string, or strip, indicated at 72, and a second portion formed or defined as sections indicated at 16, 26, and 36 of respective panels 10, 20, and 30 where adhesive is not applied. As shown in FIG. 1, tear strip 72 does not receive adhesive therealong. Tear strip 72 generally is defined or bounded by tear lines 84 and 94 that extend from the periphery 8 of panel 10 across panel 10 to the intersection with fold line 11. Tear strip 72 is defined in panel 20 between fold lines 11 and 21 and between tear lines 86 and 96. Tear strip 72 is defined at least partially in panel 30 as extending from fold line 21 into panel 30 between tear lines 88 and 98. Thus, tear strip 72 includes three segments that extend in a generally continuous manner from the blank periphery 8 through panel 10, through panel 20, and into panel 30.

Tear strip 72 can include an initiation feature, tab, or another type of opening assist feature 71 to help begin removal of tear strip 72 from the carton by separating along the tear lines by separating the segments 74, 76, 78 along the tear lines 84, 94, 86, 96 and 88, 98. Tab 71 can extend from the periphery of panel 10 and generally is coextensive with tear strip 72. The tear strip 72 also can be detached along the tear lines to create a lid, as shown in FIG. 3. The lid feature includes segment 16 in panel 10, portion 26 in panel 20, and segment 36 is in panel 30. As shown in FIG. 1, tear line segments 81 and 82 are disposed in generally diagonal orientations, but do not necessarily have to be disposed in such oblique fashion, with other orientations being within the understanding of those of ordinary skill in the art. As also shown in FIG. 1, glue pattern 60 extends from tear line 81 to the periphery of panel 10, and between fold line 15 and tear line segment 84 in panel 10. The tear line segments 82, 84, 86, 88, 94, 96, 98 can be generally referred to as tear line pattern 80, which generally defines both dispensing feature 70 and tear strip 72. Additional segments of tear lines further can be included to allow the dispensing flap 70 to perform the features as detailed herein.

FIG. 2 shows blank 5 of FIG. 1 with a second blank 105 applied thereover. Generally, blank 105 is sized to be substantially similar in length to panels 10, 20, 30, 40, and adhesive flap 50 of blank 5 as shown in FIG. 1 and as detailed above. However, to enable a carton, such as the carton 200 shown in FIG. 3, to be formed, the second blank 105 as shown in FIG. 2 can be sized slightly smaller in width than blank 5 to the distance between fold lines 53 and 55. The width or sizing of second blank 105, when attached to first blank 5 to form combination blank 205, generally will enable the end flaps 12, 22, 32, 42 at the first end 204 and end flaps 14, 24, 34, 44 at the second end 206 to be more easily folded to create a top and bottom closure of the carton 200 as shown in FIG. 3.

As shown in FIG. 2, blank 105 is applied onto adhesive or glue pattern 60 over blank 5 and typically covers a dispensing flap or portion 70 defined therealong. Blank 105 is generally not adhered to blank 5 along tear strip 72 or along dispensing portion 70. As a result, a combination blank 205 is formed with the overlapping blank 105 defining a reinforcing ribbon 115 or area for the blank 205 by providing an area of increased thickness and support to the carton formed from the blank. This can enable easier and efficient formation of a reinforced carton without necessarily requiring further specialty manufacturing operations.

To form the combination blank 205 into carton 200 (FIG. 3), panels 210, 220, 230, 240, 250 generally are folded about fold lines 211, 221, 231, 241 to form a sleeve. Fold lines 211, 221, 231, 241 generally are foamed by aligning fold lines of blank 105 with fold lines 11, 21, 31, and 41 of blank 5. Next, the end flaps are folded toward the interior of the sleeve to close both ends of the carton. Either the top end flaps or the base end flaps can be enclosed first. For example, to form the combination blank 205 into carton 200 (FIG. 3), the top end flaps 14, 24, 34 and 44 can be folded inward. For example, generally, end flaps 14 and 34 will be folded inwardly prior to folding end flaps 24 and 44 inward. In this scenario, an adhesive can be applied to either the exterior surfaces of end flaps 14 and 34, which will be adhered to interior surfaces of end flaps 24 and 44. Similarly, for example, end flaps 12 and 32 generally will be folded inwardly prior to folding of end flaps 22 and 42 to form the bottom end of carton 200. An adhesive can be applied at least to sections of exterior surfaces of end flaps 12 and 32, which can be received by interior surfaces of end flaps 22 and 42 when folded to foam the bottom end of carton 200.

FIG. 3 shows carton 200 erected from combination blank 205 (FIG. 2). An exemplary method of forming the carton can include folding combination panels 210 and 230 along fold lines 211 and 221 so as to extend perpendicularly from combination panel 220. Combination panel 240 can then be folded along combination fold line 231 and combination adhesive flap 250 can be folded along combination fold line 241 to extend combination panels 240 and 220 generally parallel to one another and combination panels 210, 240 and combination adhesive flap 250 generally parallel to one another. An adhesive then can be applied to adhesive flap or panel 250, which generally is received along an exterior surface of blank 205 at combination panel 210. The adhesive can be applied to an exterior surface of blank 205 at adhesive flap 250 to be received along the interior of combination flap 210. In this orientation, combination flap 250 and combination panel 210 are generally parallel and coextensive therealong the length of combination panel 250 with combination panels 210 and 230 being parallel and substantially perpendicular to combination panels 220 and 240. Then, as described in the example above, end flaps 14 and 34 are folded inwardly, and end flaps 24 and 44 are folded inwardly to form a top end. At the bottom end, end flaps 12 and 32 are generally folded inward initially and end flaps 22 and 42 are folded inwardly to close the bottom of the carton.

When it is desired to open the carton 200, the tear strip 72 generally is detached along tear line 80. In one exemplary method, tear strip 72 is initially detached by gripping initiation flap 71 and detaching the tear strip 72 along tear line segments 84 and 94. Detachment along the tear lines continues into combination panel 220 along tear lines 86 and 96, and then continues along tear line segments 88 and 98 into combination panel 230, until separation of tear strip 72 is complete. Tear strip 72 typically can be entirely removed from carton 200, but, as desired, tear strip 72 also could remain attached to carton 200.

To operate dispensing flap 70 (which generally forms the lid) once the tear strip 72 has been detached, generally the dispensing flap 70 is activated by separating the flap along tear line segments 81 and 82 and then hinging the flap 70 or lid upward to expose opening 300 of carton 200 as shown in FIG. 3. Segments 16, 26, 36 of dispensing flap 70 form depending lips that generally are sized to interest with upstanding wall segments 116, 126, and 136 of blank 105 to create an interference fit. These upstanding wall segments 116, 126, and 136 of blank 105 form an interference or retention surface 275 capable of allowing the dispensing flap 70 to be held in a closed arrangement without the use of additional means, such as locks, flaps, etc. Generally, the dispensing flap 70 or lid is foldable or hingable along fold line 45 to allow reclosing of the dispensing flap 70 to block or occlude opening 300. As shown in FIG. 3, upstanding portions 116, 126, and 136 extend deeply into the carton 200, with the deep extension contributing to the interference fit. Prior to closing the top end of the carton 200, the interior of the combination blank, once formed into a construct that allows receipt of product, may be loaded with desired contents or articles.

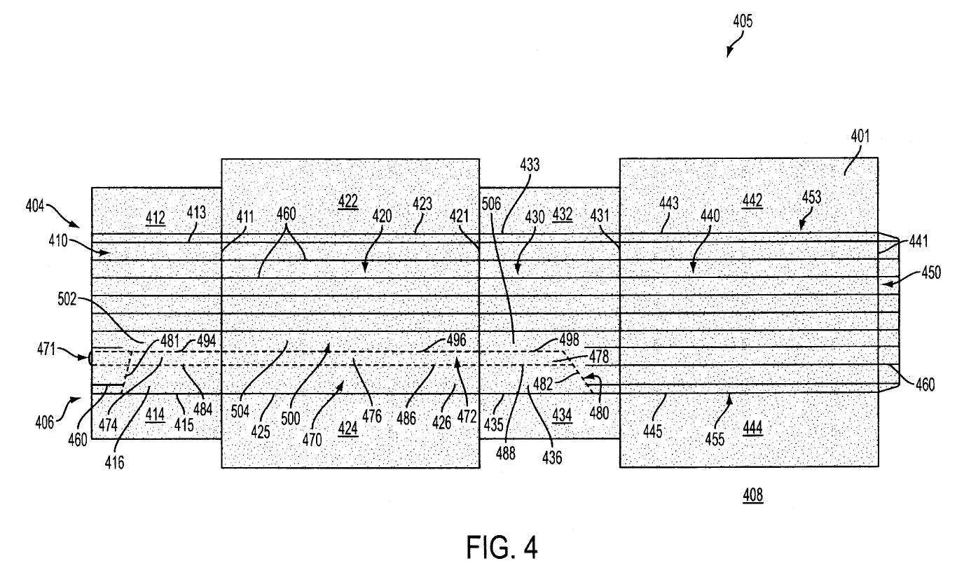

FIG. 4 shows a configuration of an alternate embodiment of the present invention. As shown in FIG. 4, blank 405 has substantially similar, corresponding features to blank 5 of FIG. 1, but includes a different adhesive pattern 460 that creates a sift pocket formation in certain areas of panels 410, 420, and 430. Briefly described, blank 405 includes a first end 404 and a second end 406, with panels 410, 420, 430, 440, and an adhesive flap 450. Panel 410 is connected along a fold line 411 to panel 420, panel 420 is connected along a fold line 421 to panel 430, panel 430 is connected along a fold line 431 to panel 440, and panel 440 is connected along a fold line 441 to adhesive flap 450.

At the first end 404, an end flap 412 is connected along a fold line 413 to panel 410, at the second end, and end flap 414 is connected along a fold line 415 to panel 410. An end flap 422 also is connected along a fold line 423 to panel 420 at the first end 404, and at the second end 406, an end flap 424 is connected along a fold line 425 to panel 420. At the first end 404, an end flap 432 is connected along a fold line 433 to panel 430, and at the second end 406, an end flap 434 is connected along fold line 435 to panel 430. At the first end 404, an end flap 442 is connected along a fold line 443 to panel 440, and at the second end 406, an end flap 444 is connected along a fold line 445 to panel 440. Fold lines 413, 415, 423, 425, 433, 435, 443, 445 are generally transverse to fold lines 411, 421, 431, 441. One or more of fold lines 413, 423, 433, 443 could be replaced by a single fold line, such as indicated at 453, and one or more of fold lines 415, 425, 435, 445 could be replaced by a single fold line, such as indicated at 455. End flaps 412, 414, 422, 424, 432, 434, 442, 444 generally extend in a direction away from respective fold lines 413, 415, 423, 425, 433, 435, 443, 445 toward periphery 408 of blank 405.

A dispensing feature 470 is shown in FIG. 4, and generally is defined by a series of tear lines 480. Tear strip 472 includes an initiation flap 471 that extends from the periphery of panel 410. Tear strip 472 extends from initiation flap 471 through panel 410 to fold line 411 between tear line segments 484 and 494. Tear strip 472 extends between fold lines 411 and 421 along tear line segments 486 and 496 in panel 420. Tear strip 472 extends from fold line 421 into panel 430 between tear line segments 488 and 498 to tear line segment 482. Tear line segment 481 extends from tear line segment 494 to fold line 415. Tear line segment 482 extends from an end point of tear line segment 498, to an end line segment of tear line segment 488, and then to fold line 435. The tear line segments 481 and 482 are shown as extending in a generally diagonal or oblique direction in respective panels 410 and 430, but could extend in other orientations. Thus, tear strip or flap 472 includes a segment 474 in panel 410 as defined between tear line segments 481, 484, 494, and fold line 411. Tear line segment 474 is defined at its perimeter by a segment of fold lines 411 and 421 and between tear line segments 486 and 496. Tear strip segment 478 of tear strip 472 is defined in panel 430 between tear line segments 482, 488, 498, and a segment of fold line 421. Accordingly, tear strip 472 extends generally from tear line portion 471, 474, 476, 478 in a generally continuous manner thereof. Dispensing flap 470 includes portions 416, 426, 436 in panels 410, 420, 430, respectively at the second end 406 of blank 405 adjacent fold line 455.

As also shown in FIG. 4, a sift pocket 500 can be formed in blank 405. Generally, sift pocket 500 can be formed by omission of adhesive portions 460 along segments of panels 410, 420, 430 of blank 405. Sift pocket 500 includes a segment 502 formed in panel 410, a segment 504 formed in panel 420, and a segment 506 formed in panel 430. This omission of glue in segments 502, 504, 506 creates the opening feature and forms a “sift” pocket. Glue pattern 460 extends in substantially similar areas to glue pattern 60 (FIG. 1), however, glue is omitted above the tear strip 472 at segments 502, 504, 506 to form “sift” pocket 500 in blank 405.

The present disclosure describes a tear string or strip utilized in a reinforced carton formed from a paperboard blank or sleeve. The tear string placement and the adhesive allow registration of reinforcing ribbon(s) in place in a reinforced blank to form a carton. The present disclosure also describes a glue system that allows such registration that does not provide glue in an unglued portion above the tear strip and in certain areas adjacent and above the tear strip.

The machinery used to form the present cartons can utilize a registration system, such as one using UPC codes to register the web, blank, tear string, reinforcing ribbon(s), or any or all combinations of these or others to dispose accurately the ribbons on the blank or web.

The cartons formed from the reinforced blanks described herein generally provide a lid formed by removal of a tear string from the carton. Although the invention should not be limited to the arrangement shown in the figures, the lid is shown formed along the areas defined by the diagonal cuts and tear string. As shown, the lid includes three depending lips formed from areas that did not receive adhesive when applying the reinforcing ribbon(s). The diagonal cuts generally are deep enough into the center portion (as measured from the fold lines separating the panels from the end flaps) of the blank or web to provide an interference fit for the lid. Specifically, the diagonal cuts extend away from the fold lines separating the panels from the end flaps deeply enough to allow the lid to provide a friction fit to restrict dislodgement of the lid once closed, at least until product dispensing is desired. Once the tear string is removed, the lid is opened by moving the lid upward with enough force to overcome the friction provided by the interference fit with the upstanding sections of the reinforcing ribbon.

The cut and scored carton blanks may be palletized and shipped to packagers, where the blanks are converted into cartons and packed with articles such as, for example, beverage containers or food items. When converted to cartons, the previously positioned and applied paperboard reinforcing ribbons form multiple layers or laminations of paperboard in selected portions of the cartons such as, for example, in their sides, where enhanced structural integrity is required. By appropriately selecting, sizing, and positioning the reinforcing ribbons, paperboard cartons having strength and rigidity comparable or superior to that provided by cartons made of micro-flute are obtained.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. It is within the scope of the present disclosure for each of the tear lines to be replaced with a continuous slit, or the like. For example, a cut line can be a continuous slit or can be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A combination blank comprising:
a first blank attached to a second blank by an adhesive;
the first blank comprising a first panel connected to a second panel along a first fold line, the second panel connected to a third panel along a second fold line, the third panel connected to a fourth panel along a third fold line, and the fourth panel connected to a fifth panel along a fourth fold line; the first blank including first end flaps disposed along a first transverse fold line and second end flaps disposed along a second transverse fold line; the first transverse fold line and the second transverse fold line being transverse to the first fold line, the second fold line, the third fold line, and the fourth fold line; the first transverse fold line being spaced a first distance from the second transverse fold line; the first blank including a dispensing flap pattern;
the second blank including a first panel, a second panel, a third panel, a fourth panel, and a fifth panel; each of the first panel, the second panel, the third panel, the fourth panel, and the fifth panel of the second blank having a width less than the first distance; and,
the combination blank including a first combination panel comprising the first panel of the first blank and the first panel of the second blank, a second combination panel comprising the second panel of the first blank and the second panel of the second blank, a third combination panel comprising the third panel of the first blank and the third panel of the second blank, a fourth combination panel comprising the fourth panel of the first blank and the fourth panel of the second blank, and a fifth combination panel comprising the fifth panel of the first blank and the fifth panel of the second blank;
wherein an adhesive is applied to either the first blank or the second blank to attach the first blank to the second blank to form the combination blank;
wherein the adhesive is not applied to the dispensing flap pattern.

2. The blank of claim 1 wherein the first blank includes a tear strip.

3. The blank of claim 2 wherein the tear strip is adjacent the dispensing flap pattern.

4. The blank of claim 1 wherein a reinforcing ribbon is defined along an area of overlap between the first and second blanks.

5. The blank of claim 1 wherein the dispensing flap pattern is defined at least partially by at least one tear line.

6. The blank of claim 5 wherein the at least one tear line includes a tear line pattern.

7. The blank of claim 1 wherein the first blank includes a sift pocket formation.

8. The blank of claim 7 wherein the adhesive is not applied to the sift pocket formation.

9. The blank of claim 7 wherein the first blank further comprises a tear string; the tear string being positioned between the sift pocket formation and the dispensing flap pattern.

10. A carton formed from a combination blank, the combination blank including a first blank attached to a second blank by an adhesive, the first blank comprising a first panel connected to a second panel along a first fold line, the second panel connected to a third panel along a second fold line, the third panel connected to a fourth panel along a third fold line, and the fourth panel connected to a fifth panel along a fourth fold line, the first blank including first end flaps disposed along a first transverse fold line and second end flaps disposed along a second transverse fold line, the first transverse fold line and the second transverse fold line being transverse to the first fold line, the second fold line, the third fold line, and the fourth fold line, the first transverse fold line being spaced a first distance from the second transverse fold line, the first blank including a dispensing flap pattern, and, the second blank including a first panel, a second panel, a third panel, a fourth panel, and a fifth panel, each of the first panel, the second panel, the third panel, the fourth panel, and the fifth panel of the second blank having a width less than the first distance, wherein an adhesive is applied to either the first blank or the second blank, wherein the adhesive is not applied to the dispensing flap pattern; the combination blank having a first combination panel comprising the first panel of the first blank and the first panel of the second blank, a second combination panel comprising the second panel of the first blank and the second panel of the second blank, a third combination panel comprising the third panel of the first blank and the third panel of the second blank, a fourth combination panel comprising the fourth panel of the first blank and the fourth panel of the second blank, and a fifth combination panel comprising the fifth panel of the first blank and the fifth panel of the second blank, the carton comprising:
a first side formed from the first combination panel and the fifth combination panel, with the first combination panel and the fifth combination panel being attached together;
a second side formed from the second combination panel;
a third side formed from the third combination panel;
a fourth side formed from the fourth combination panel;
a first end formed from the first end flaps; and
a second end formed from the second end flaps.

11. The carton of claim 10 wherein the first blank includes a tear strip.

12. The carton of claim 11 wherein the tear strip is adjacent the dispensing flap pattern.

13. The carton of claim 11 wherein the adhesive is not applied to the tear strip.

14. The carton of claim 10 wherein the dispensing flap pattern is defined at least partially by at least one tear line.

15. The carton of claim 14 wherein the at least one tear line includes a tear line pattern.

16. The carton of claim 10 wherein the first blank includes a sift pocket formation.

17. The carton of claim 10 wherein a reinforcing ribbon is defined along an area of overlap between the first and second blanks.

18. The carton of claim 16 wherein the first blank further comprises a tear string; the tear string being positioned between the sift pocket formation and the dispensing flap pattern.

19. A method of forming a carton from a combination blank, the method comprising:
providing a first blank, the first blank comprising a first panel connected to a second panel along a first fold line, the second panel connected to a third panel along a second fold line, the third panel connected to a fourth panel along a third fold line, and the fourth panel connected to a fifth panel along a fourth fold line; the first blank including first end flaps disposed along a first transverse fold line and second end flaps disposed along a second transverse fold line; the first transverse fold line and the second transverse fold line being transverse to the first fold line, the second fold line, the third fold line, and the fourth fold line; the first transverse fold line being spaced a first distance from the second transverse fold line; the first blank including a dispensing flap pattern;
providing a second blank, the second blank including a first panel, a second panel, a third panel, a fourth panel, and a fifth panel; each of the first panel, the second panel, the third panel, the fourth panel, and the fifth panel of the second blank having a width less than the first distance;
applying an adhesive to either the first blank or the second blank; and,
forming the combination blank by attaching the first blank to the second blank along the adhesive, the combination blank including a first combination panel comprising the first panel of the first blank and the first panel of the second blank, a second combination panel comprising the second panel of the first blank and the second panel of the second blank, a third combination panel comprising the third panel of the first blank and the third panel of the second blank, a fourth combination panel comprising the fourth panel of the first blank and the fourth panel of the second blank, and a fifth combination panel comprising the fifth panel of the first blank and the fifth panel of the second blank;
wherein the adhesive is not applied to the dispensing flap pattern.

20. The method of claim 19 wherein the first blank includes a tear strip.

21. The method of claim 20 wherein the tear strip is adjacent the dispensing flap pattern.

22. The method of claim 20 wherein the adhesive is not applied to the tear strip.

23. The method of claim 19 wherein the dispensing flap pattern is defined at least partially by at least one tear line.

24. The method of claim 23 wherein the at least one tear line includes a tear line pattern.

25. The method of claim 19 wherein the first blank includes a sift pocket formation.

26. The method of claim 25 wherein the adhesive is not applied to the sift pocket formation.

27. The method of claim 25 wherein the first blank further comprises a tear string; the tear string being positioned between the sift pocket formation and the dispensing flap pattern.

28. A method of forming a reinforced carton, the method comprising:
forwarding a web of paperboard along a first path;
forwarding at least one tear string along a second path;
adhering the tear string to the web by an adhesive on an interior surface of the web;
applying and adhering at least one reinforcing ribbon over the tear string to first areas of the interior surface of the web, and not to second areas of the interior surface of the web;
cutting a blank from the web;
diagonally cutting from the exterior side of the blank at least one cut partially through the areas not receiving adhesive, the at least one cut extending through the blank and through the tear string but not through the at least one reinforcing ribbon; and,
forming a carton from the blank.

29. The method of claim 28 wherein the adhesive is applied to the web and not the at least one reinforcing ribbon.

30. The method of claim 28 wherein the adhesive is applied to the at least one reinforcing ribbon and not the web.

31. The method of claim 28 wherein the second areas include a first section above the tear string and a second section between the tear string and the periphery of the at least one reinforcing ribbon.

32. The method of claim 28 wherein the cutting and diagonally cutting steps are performed simultaneously.

33. The method of claim 28 wherein the at least one reinforcing ribbon includes at least two ribbons.
